(19) United States
(12) Patent Application Publication
(10) Pub. No.: US 2010/0205063 A1
(43) Pub. Date: Aug. 12, 2010

(54) ELECTRONIC PAYMENT TRANSACTION SYSTEM

(76) Inventor: Randy Mersky, Silver Spring, MD (US)

Correspondence Address: GREENBLUM & BERNSTEIN, P.L.C., 1950 ROLAND CLARKE PLACE, RESTON, VA, 20191, US

(21) Appl. No.: 12/617,978

(22) Filed: Nov. 13, 2009

Related U.S. Application Data
(63) Continuation-in-part of application No. 11/213,843, filed on Aug. 30, 2005.
(60) Provisional application No. 60/605,134, filed on Aug. 30, 2004.

(51) Int. Cl. G06Q 20/00

(52) U.S. Cl. 705/17; 705/24; 705/40; 705/44; 235/379

(57) ABSTRACT

A method of pre-staging a financial transaction includes sending payment information entered using a device at a user location, via an electronic communication channel, for pre-staging the financial transaction. The method includes receiving a pre-staged transaction receipt corresponding to the financial transaction from an intermediary entity implemented on at least one processor. The method also includes manually tendering a payment amount, the payment amount corresponding to the payment information and the pre-staged transaction receipt, at a retail location. The method also includes paying a payee the payment amount, the payee being specified in the payment information, based on matching a transaction request from the retail location with the pre-staged financial transaction.

### CROSS REFERENCE TO RELATED APPLICATIONS

This is a Continuation-in-part of pending U.S. patent application Ser. No. 11/213,843, filed on Aug. 30, 2005, which claims priority of U.S. Provisional Application 60/605,134 filed Aug. 30, 2004 entitled “Kiosk for Processing Payment Information”, each of which is incorporated herein by reference in its entirety.

### BACKGROUND OF THE INVENTION

1. Technical Field

The present disclosure pertains to processing payment information. In particular, the present disclosure pertains to a system that conducts transactions (e.g., paying bills, sales of goods and/or services, etc.) over a network and enables users to tender payment manually (e.g., tender payment in the form of cash, check, etc.) for those transactions.

2. Discussion of Related Art

Generally, consumer creditors (e.g., utility companies, banks, credit card companies, department stores, etc.) periodically send statements to notify customers of account balances and requesting payment. The statement includes a summary of account activity and a payment coupon stating the amount due to the creditor or owed to the customer. When an amount is due to the creditor, the consumer typically remits payment to the creditor within a reasonable period of time after receiving the creditor statement. The remittance contains a check (drawn on the consumer's bank) and the payment coupon. The creditor then encodes the amount of the remittance onto the check, deposits the check, and credits the consumer's account in a customer general ledger (“G/L”) account database. Alternately, the remittance is mailed to a lockbox operator who opens the remittance, encodes the check, and captures the consumer's banking information electronically to create an A/R data file. The lockbox operator then sends the A/R data file to the creditor, while sending the encoded check to the bank to be credited to the creditor's bank account. When the consumer's bank receives the check, it withdraws the amount of the check from the consumer's bank account and passes the funds to the creditor's bank account. At some time following the clearing of the check, the creditor also updates its A/R records in the G/L database to credit the consumer's account, and the consumer's bank confirms to the consumer that the withdrawal of the amount of the check by listing it on statement and/or by returning the cancelled check.

Alternatively, customers may arrange to have payments automatically transferred from a customer's bank account to a creditor's account by electronic transfer. This relieves the customer from completing and mailing a check each billing period, and incurs a savings to the customer since the customer does not need to purchase stamps to mail payments.

Furthermore, a user may use an ATM-type system to pay a bill. In such systems, an ATM network access device retrieves bank account information from an ATM card inserted by a consumer to initiate an ATM transaction, and receives appropriate associated PIN information and transaction information from the consumer. The consumer's banking institution verifies the user's account data and verifies that the user has sufficient funds available for the requested transaction. Upon receipt of the authorization message, the ATM banking institution forwards the authorization to the ATM network access device, providing suitable information and funds, if requested, to the user. The consumer then designates the creditor payment and the amount to be paid. Once the consumer has terminated the ATM banking session, the ATM transaction processor forwards a confirmation record of the completed transaction to the ATM banking institution and forwards a record of the transaction and information to facilitate the appropriate debiting and crediting of the necessary accounts to a designated ACH network. The ACH network then operates to debit (where the user has requested a withdrawal of funds, for example) the user's account at the consumer banking institution, and to issue a credit to the ATM banking institution.

There are, moreover, several prior art systems that facilitate customer payment of bills to creditors. For example, U.S. Pat. No. 5,220,501 (Lawlor et al) discloses a system enabling a customer to communicate with a service provider computer from a remote computer site, preferably the customer's home, to facilitate bill paying and/or banking functions. The service provider computer accesses the customer bank computer to selectively perform several banking functions (e.g., account balance inquiries, transfer of funds between accounts, etc.) and pay bills by electronically transferring funds from the customer's account.

U.S. Pat. No. 5,326,959 (Perazzo) discloses a system that enables customer payment of bills to creditors via electronic fund transfers from a customer bank account based on forms submitted by the customer to the customer bank indicating the creditor to receive payment and the payment amount.

U.S. Pat. No. 5,351,994 (Pollin) and U.S. Pat. No. 5,504,677 (Pollin) disclose a system that enables customer payment of bills to creditors by generating a draft payable to the creditor and drawn on the customer's bank account wherein the creditor executes the draft as an authorized signatory for the customer and deposits the payment in the creditor account.

U.S. Pat. Nos. 6,119,106 and 6,611,818 (both to Mersky et al.) disclose a system for facilitating customer payments to creditors from a remote site including computer systems located at respective agent affiliate, service provider, and creditor sites. The service provider or host computer system is in selective communication with the agent and creditor computer systems and processes any transaction information. A customer typically visits an agent affiliate site and tenders payment in response to receiving a billing statement from a creditor. An agent operator enters all the customer account information and receives payment, applying it to the designated creditor account balance. The payment transaction is entered into the agent system, which, along with other payment transaction information from the agent site, is maintained in a transaction file. The agent system generates a receipt for the customer at the completion of the transaction. Each agent system transfers a transaction file to the host system, and the host system processes the transaction files to generate a closeout report and a creditor report for each creditor indicating the payment activity at the agent sites.

The prior art, however, suffers from several significant disadvantages. Specifically, when a consumer remits payment by check, if the funds are not available in the consumer's account to cover the amount of the check, or if the consumer's account has been closed, then the consumer's bank will return the check to the creditor's bank, which will, in turn, return the check to creditor. The creditor will then have to reverse the transaction crediting the consumer's account in the G/L database and renegotiate payment from consumer, all at significant cost to the creditor. Even if the check clears, the process of providing good funds to creditor is not instantaneous, since the check must physically travel from the creditor's bank to the consumer's bank. If the check doesn't clear, then the creditor and any other parties to the transaction must unwind the payment. Furthermore, payment through the mail not only requires payment of postage, but crates a level of unpredictability, since a consumer does not know when the payment will arrive at the billing institution.

With ATM transactions, the consumer is usually limited to making bill payments only to certain entities specified in advance by the bank, and is required to complete a somewhat onerous registration process for establishing ATM-based bill payment authority or privileges. In addition, a user is not only subjected to severe transaction fees, but also to administrative inefficiencies caused by various billing institutions utilizing different and independent accounts to conduct transactions. In addition, both traditional and ATM systems tend to require the use of pre-existing monetary accounts to conduct transactions remotely, thereby limiting manners of facilitating consumer payment and restricting use of the systems to consumers that can establish the required accounts. Many consumers, moreover, prefer human interaction, being more comfortable tendering payment to an agent of the billing institution rather than a stand-alone computer system.

Furthermore, the prior art systems generally rely on computers or other devices to enable customer payment to creditors by electronically transferring funds between customer and creditor bank accounts. However, these systems are unavailing for customers who do not have a computer or do not have a checking or other bank account. In addition, the prior art systems are typically limited to facilitating customer payment to creditors with a specific type of payment (e.g., electronic fund transfer), and do not accommodate customers that desire, or are only able, to pay creditors with some other form of payment, such as cash. Moreover, a customer using prior art systems typically must authorize and arrange for electronic transfer of funds with the creditor and/or bank in order to enable payment to creditors. This authorization process generally includes submission of various forms by the customer and/or creditor to the customer bank and creditor bank, thereby imposing additional burdens on the parties involved. Although creditors may have offices that are capable of receiving customer payments in various payment forms (e.g., cash), these payments must be received and processed in the creditor's offices during creditor office hours. This is especially distressing for customers that need to make emergency payments (e.g., payments due that day) to avoid lateness and/or other penalties when the creditor's offices are closed.

Additionally, the remote payment system of the Mersky patents, though addressing several of the aforementioned drawbacks, requires an operator to enter the pertinent customer account information, increasing the time the operator must spend with each customer, and increasing the wait times for customers requiring assistance. In addition, an agent operator, when entering customer information into the agent computer system, is more likely to make mistakes since the information is not familiar to the operator. This, in turn, causes further delays in processing the payment. Scanners, though helpful in entering information accurately, are prone to read errors, and have no effectiveness when the customer does not have a bill to scan.

Furthermore, existing, clerk-only systems (i.e., those having no kiosk) do not effectively communicate with the creditors to provide payment by a due date. Many service providers have trustees that collect payments for up to 50 creditors. The host or service providers have various contracted arrangements with each creditor, which often have varying fees, crediting, and posting times, as well as cut-off times, all of which are critical to reinitiate a particular service (e.g., electricity) or to prevent a service disconnect. It is becoming increasingly difficult for service providers to effectively communicate these variations in processing to customers.

Kiosk-only (bill collector) systems require a user to dispense cash directly into the kiosk via a cash acceptor. Since each piece of paper currency must be entered individually, the process is time consuming. In addition, cash acceptors are often unreliable, becoming jammed and preventing the use of the kiosk. Along with cash acceptors, such devices further require change generators, requiring the kiosk to store large amounts of cash and additional processing costs (emptying, counting, and filling the cash within the kiosk). Consequently, kiosks with cash handling are generally expensive, large, are difficult to maintain, and limit the number of transactions that can be taken in a day.

Consequently, there exists a need for a payment system that provides timely (real time) information to a customer and creditors regarding an account, and avoids the problems associated with kiosk (ATM) only systems, and permits tender of payment (e.g., cash) at a remote site without the inefficiencies caused by the aforementioned processes.

### SUMMARY OF THE INVENTION

Accordingly, it is a feature of the present disclosure to facilitate customer payment to creditors with various forms of payment (e.g., check, cash, credit card, etc.) from a remote site (e.g., a local retail establishment).

It is another feature of the present disclosure to facilitate customer payment to creditors from remote sites (e.g., local retail establishments) commonly having substantial business hours, thereby enabling customers to pay creditors from remote sites during respective remote site business hours typically spanning a substantial portion of a day.

Yet another feature of the present disclosure is to facilitate customer payment to creditors from a remote site without requiring the customer to authorize, register for, or pre-arrange the payment transaction with the creditor.

Still another feature of the present disclosure is to reduce payment processing costs for creditors by arranging for a single payment to the creditor for numerous customer accounts.

It is still a further feature of the present disclosure to facilitate tender of payment manually (e.g., tender of payment in the form of cash, check, etc.) for transactions conducted over a network.

It is another feature of the present disclosure to conduct transactions over a network while maintaining consumer anonymity and privacy.

Yet another feature of the present disclosure is to enable consumers without possession of a computer system to conduct transactions over a network.

The aforesaid features are achieved individually and/or in combination, and it is not intended that the present disclosure be construed as requiring two or more of the features to be combined unless expressly required by the claims attached hereto.

According to the present disclosure, a system for facilitating customer payment to creditors from a remote site includes a plurality of trustee computer systems each associated with a kiosk. The trustee computer system and the kiosk are both located at the remote (trustee) site (e.g., a local retail establishment). The payment system further includes a host computer system residing at a site associated with a service provider, wherein the host computer system is capable of selectively communicating with both the trustee computer system and the kiosk system in real time.

In operation, a plurality of creditor computer systems typically resides at different sites associated with creditors (e.g., utility or other companies) affiliated or under contract with the service provider, wherein the creditor computer systems are preferably in selective communication with the host computer system for transmitting customer account information. In response to receiving a creditor statement, a customer using the system visits one of the trustee sites (e.g., businesses) and manually tenders payment. Specifically, the customer interacts with the kiosk located at the trustee site to access the creditor account, entering information relating to the customer (name, address, customer account number with the creditor, and/or the amount due). Information of this transaction is saved in a transaction file within the kiosk, which is identified using a personal/process identification number (PIN). The customer receives the PIN and visits a clerk or operator located at the trustee site. The clerk enters the PIN into the trustee computer system. The trustee system communicates with the kiosk, verifying the PIN and accessing the transaction file. The clerk enters the dollar amount tendered by the customer into the trustee computer system, which, in turn, communicates with the kiosk to validate payment and update the transaction file, applying the tendered amount to the account balance due. The kiosk system transmits transaction information to the host computer system.

The host system receives the transaction information from each trustee system and sorts the information. The host system may create a transaction report for each creditor affiliated or under contract with the service provider. Once the transaction reports are generated, the reports are transmitted to the appropriate creditor computer systems in order to credit customer payments to the corresponding customer accounts. Alternatively, the host computer system may generate transaction reports for each creditor affiliated with the service provider, and send the reports to the creditors in any conventional manner (e.g., facsimile, ground transport mail, etc.). Creditors may use the reports to apply the customer payments to the appropriate customer accounts in any conventional manner (e.g., enter the payments into the creditor computer system). The system operator or service provider receives funds from each of the trustees and pays each of the creditors via electronic fund transfer or other conventional payment form. The host system may further generate a closeout report containing transaction information for all transactions occurring at the respective remote sites. The report is typically printed at a predetermined time after all the transaction information has been received from the remote computer systems.

The present disclosure may be additionally utilized for other applications, including but not limited to, receiving a disbursement from a creditor, purchasing money orders, purchasing pre-paid telephone cards, or purchasing additional minutes for a wireless (mobile) phone. The transaction reports may then be sent to the respective money order or telephone companies.

According to a feature of the present disclosure, a method of pre-staging a financial transaction includes sending payment information entered using a device at a user location, via an electronic communication channel, for pre-staging the financial transaction. The method includes receiving a pre-staged transaction receipt corresponding to the financial transaction from an intermediary entity implemented on at least one processor. The method also includes manually tendering a payment amount, the payment amount corresponding to the payment information, and the pre-staged transaction receipt at a retail location. The method further includes paying a payee the payment amount, the payee being specified in the payment information, based on matching a transaction request from the retail location with the pre-staged financial transaction.

According to another feature of the present disclosure, the financial transaction is pre-staged with the intermediary entity.

According to yet another feature of the present disclosure, the payment information includes a payee name, a payee address, the payment amount, a payee telephone number, a payee email address, a payor address, a payor email address, payor telephone number, payor mobile number, an account number, an account balance and a balance due.

According to still another feature of the present disclosure, the retail location and the user location are geographically distinct from each other.

According to a feature of the present disclosure, the pre-staged transaction receipt includes at least one of: a radio frequency identifier (RFID) tag, a bar code, a magnetic strip, a graphic file, a hologram and an alphanumeric character string.

According to another feature of the present disclosure, the intermediary entity matches the transaction request from the retail location with the pre-staged financial transaction.

According to still another feature of the present disclosure, the retail location and the user location are situated at a common geographic location.

According to a feature of the present disclosure, the method includes receiving a payment receipt from the retail location.

According to another feature of the present disclosure, the method includes receiving a confirmation of payment via at least one of the payor email address, the payor address, the payor telephone number and the payor mobile number.

According to yet another feature of the present disclosure, a payor enters the payment information.

According to still another feature of the present disclosure, the device includes at least one of: a personal computing device, a personal digital assistant (PDA), a mobile device and a set-top box.

According to a feature of the present disclosure, the payor enters the payment information to a website for the intermediary entity.

According to another feature of the present disclosure, the pre-staged transaction receipt is sent to at least one of: the device, a printer, a personal digital assistant (PDA), a mobile device, a set-top box and a pager and the device comprises computing device.

According to yet another feature of the present disclosure, the intermediary entity stores the pre-staged financial transaction and the intermediary entity receives the transaction request from the retail location.

According to a feature of the present disclosure, a system of pre-staging a financial transaction includes an intermediary entity processor which receives payment information that pre-stages the financial transaction from a device over an electronic communication channel, the intermediary entity processor sending a pre-staged transaction receipt to the computing device. The system includes a retail processor which processes the pre-staged transaction receipt and a payment amount specified by the payment information, the payment amount and the pre-staged transaction receipt being manually tendered by a user at a retail location, the retail processor sending a transaction request to the intermediary entity processor. The intermediary entity processor pays a payee the payment amount, based on matching the transaction request with the pre-staged financial transaction.

According to another feature of the present disclosure, the financial transaction is pre-staged by an intermediary entity hosting the intermediary entity processor and the pre-staged transaction receipt corresponding to the financial transaction is generated by and received from the intermediary entity.

According to yet another feature of the present disclosure, the payment information includes: a payee name, a payee address, the payment amount, a payee telephone number, a payee email address, a payor address, a payor email address, a payor telephone number, a payor mobile number, an account number, an account balance and a balance due.

According to still another feature of the present disclosure, the retail processor and the intermediary processor are located at a shared geographic location.

According to a feature of the present disclosure, the pre-staged transaction receipt includes at least one of: a radio frequency identifier (RFID) tag, a bar code, a magnetic strip, a graphic file, a hologram and an alphanumeric character string.

According to another feature of the present disclosure, the retail processor provides a payment receipt from the retail location.

According to yet another feature of the present disclosure, the intermediary processor provides a confirmation of payment via at least one of the payor email address, the payor address, the payor telephone number and the payor mobile number.

According to still another feature of the present disclosure, the computing device and the retail processor are located at a shared geographic location.

According to a feature of the present disclosure, the payor enters the payment information via at least one of: the device, a personal digital assistant (PDA), a mobile device and a set-top box and the device comprises a computing device.

According to another feature of the present disclosure, the payor enters the payment information to a website implemented by the intermediary entity hosting the intermediary entity processor.

According to yet another feature of the present disclosure, the pre-staged transaction receipt is sent to at least one of: a printer, the device, a personal digital assistant (PDA), a mobile device, a set-top box and a pager, and the device comprises a computing device.

According to still another feature of the present disclosure, the intermediary entity stores the pre-staged financial transaction in a database.

According to a feature of the present disclosure, a tangible computer readable medium that stores a program, recorded on the computer readable medium, for pre-staging a financial transaction includes a receiving code segment, recorded on the tangible computer readable medium, that receives payment information for pre-staging the financial transaction from a device over an electronic communication channel. The tangible computer readable medium includes sending code segment, recorded on the tangible computer readable medium, that sends a pre-staged transaction receipt to the computing device. The tangible computer readable medium includes a processing code segment, recorded on the tangible computer readable medium, that processes a payment amount specified by the payment information and the pre-staged transaction receipt, the payment amount and the pre-staged transaction receipt being manually tendered by a user at a retail location.

According to another feature of the present disclosure, the processing code segment sends a transaction request to an intermediary entity implemented on at least one processor and the intermediary entity pays a payee the payment amount, based on matching a transaction request from the retail location with the pre-staged financial transaction.

According to a feature of the present disclosure, a method of pre-staging a financial transaction includes receiving payment information for pre-staging the financial transaction, from a computing device, via an electronic communication channel. The method includes sending a pre-staged transaction receipt to the computing device. The method includes receiving a transaction request from a retail processor located at a retail location at which a payor manually tenders the pre-staged transaction receipt and a payment amount corresponding to the payment information. The method includes paying a payee the payment amount based on matching a transaction request from the retail location with the pre-staged financial transaction.

According to a feature of the present disclosure, an intermediary entity processor includes a first receiver that receives payment information for pre-staging a financial transaction, from a computing device, via an electronic communication channel. The intermediary entity processor includes a transmitter that sends a pre-staged transaction receipt to the computing device. The intermediary entity processor includes a second processor that receives a transaction request from a retail location at which a payor manually tenders the pre-staged transaction receipt and a payment amount corresponding to the payment information. The intermediary entity processor includes a match processor that pays a payee the payment amount based on matching a transaction request from the retail location with the pre-staged financial transaction.

According to a feature of the present disclosure, a tangible computer readable medium storing a program, recorded on the computer readable medium, for pre-staging a financial transaction includes a first receiving code segment, recorded on the tangible computer readable medium, that receives payment information for pre-staging the financial transaction, from a computing device, via an electronic communication channel. The tangible computer readable medium includes a transmitting code segment, recorded on the tangible computer readable medium, that sends a pre-staged transaction receipt to the computing device. The tangible computer readable medium includes a second receiving code segment, recorded on the tangible computer readable medium, that receives a transaction request from a retail location at which a payor manually tenders the pre-staged transaction receipt and a payment amount corresponding to the payment information. The tangible computer readable medium includes a matching code segment, recorded on the tangible computer readable medium, that pays a payee, specified by the payment information, the payment amount based on matching a transaction request from the retail location with the pre-staged financial transaction.

According to a feature of the present disclosure, a method for pre-staging a financial transaction includes sending payment information from a computing device for pre-staging the financial transaction, via an electronic communication channel. The method includes receiving a pre-staged transaction receipt corresponding to the financial transaction from an intermediary entity implemented on at least one processor. The method includes receiving a confirmation that a payee, specified by the payment information, has been paid a payment amount corresponding to the payment information, based on matching a transaction request from a retail location with the pre-staged financial transaction, the transaction request being sent based on a payor manually tendering the payment amount and the pre-staged transaction receipt at the retail location.

According to a feature of the present disclosure, a system for pre-staging a financial transaction includes a transmitter that transmits payment information from a computing device for pre-staging the financial transaction, via an electronic communication channel. The system includes a receiver that receives a pre-staged transaction receipt corresponding to the financial transaction from an intermediary entity implemented on at least one processor, the receiver receiving a confirmation that a payee, specified by the payment information, has been paid a payment amount corresponding to the payment information, based on matching a transaction request from a retail location with the pre-staged financial transaction, the transaction request being sent based on a payor manually tendering the payment amount and the pre-staged transaction receipt at the retail location.

According to a feature of the present disclosure, a tangible computer readable medium storing a program, recorded on the computer readable medium, for pre-staging a financial transaction includes a sending code segment, recorded on the tangible computer readable medium, that sends payment information from a computing device for pre-staging the financial transaction, via an electronic communication channel. The tangible computer readable medium includes a receiving code segment, recorded on the tangible computer readable medium, that receives a pre-staged transaction receipt corresponding to the financial transaction. The tangible computer readable medium includes a second receiving code segment, recorded on the tangible computer readable medium, that receives a confirmation that a payee, specified by the payment information, has been paid a payment amount, based on matching a transaction request from a retail location with the pre-staged financial transaction, the transaction request being sent based on a payor manually tendering the payment amount and the pre-staged transaction receipt at the retail location.

According to a feature of the present disclosure, a method for pre-staging a financial transaction includes receiving a pre-staged transaction receipt and a manually tendered payment amount specified by payment information, the payment information being entered via a computing device for pre-staging the financial transaction, the pre-staged transaction receipt being generated in response to entering the payment information. The method includes sending a transaction request to an intermediary entity, the intermediary entity implemented on at least one processor and matching the transaction request with the pre-staged financial transaction. A payee, specified by the payment information, is paid the payment amount based on matching the transaction request with the pre-staged financial transaction.

According to a feature of the present disclosure, a system for pre-staging a financial transaction includes a receiver that receives a pre-staged transaction receipt and a manually tendered payment amount specified by payment information, the payment information being entered via a computing device for pre-staging the financial transaction, the pre-staged transaction receipt generated in response to entering the payment information. The system includes a transmitter that transmits a transaction request to an intermediary entity, the intermediary entity implemented on at least one processor and matching the transaction request with the pre-staged financial transaction. A payee, specified by the payment information, is paid the payment amount based on matching the transaction request with the pre-staged financial transaction.

According to a feature of the present disclosure, a tangible computer readable medium storing a program, recorded on the computer readable medium, for pre-staging a financial transaction includes a receiving code segment, recorded on the tangible computer readable medium, that receives a pre-staged transaction receipt and a manually tendered payment amount specified by payment information, the payment information being entered via a computing device for pre-staging the financial transaction, the pre-staged transaction receipt generated in response to entering the payment information. The tangible computer readable medium includes a sending code segment, recorded on the tangible computer readable medium, that sends a transaction request to an intermediary entity, the intermediary entity being implemented on at least on processor and matching the transaction request with the pre-staged financial transaction. A payee, specified by the payment information, is paid the payment amount based on matching the transaction request with the pre-staged financial transaction.

The above and still further features and advantages of the present disclosure will become apparent upon consideration of the following detailed description of a specific embodiment thereof, particularly when taken in conjunction with the accompanying drawings wherein like reference numerals in the various figures are utilized to designate like components.

### BRIEF DESCRIPTION OF THE DRAWINGS

FIG. 1 is a functional block diagram of an exemplary system for facilitating customer payments to creditors from a remote (trustee) site according to the present disclosure.

FIG. 2 is a view in perspective of an exemplary computer system employed by the present disclosure.

FIG. 3 is a view in perspective of an exemplary kiosk device according to an embodiment of the disclosure.

FIG. 4 is a procedural flowchart illustrating the manner in which a customer payment transaction is processed according to the present disclosure.

FIG. 5 is a procedural flowchart illustrating the manner in which a customer payment transaction is processed according to another embodiment of the present disclosure.

FIG. 6 is an exemplary illustration of a record structure utilized by an agent computer system to maintain customer payment transaction information according to the present disclosure.

FIG. 7 is an exemplary illustration of a creditor report generated by a host computer system containing customer payment transaction information associated with an individual creditor according to the present disclosure.

FIG. 8 is an exemplary illustration of a closeout report generated by a host computer system containing daily customer payment transaction information according to the present disclosure.

FIG. 9 illustrates a system diagram, according to a second embodiment of the present disclosure.

FIG. 10 illustrates a process flow diagram, according to a second embodiment of the present disclosure.

FIG. 11 is a detailed view of components of the system diagram illustrated in FIG. 9, according to a second embodiment of the present disclosure.

FIG. 12 illustrates a process flow diagram from a perspective of an intermediary entity and an intermediary entity processor, according to a second embodiment of the present disclosure.

### DETAILED DESCRIPTION OF THE PREFERRED EMBODIMENTS

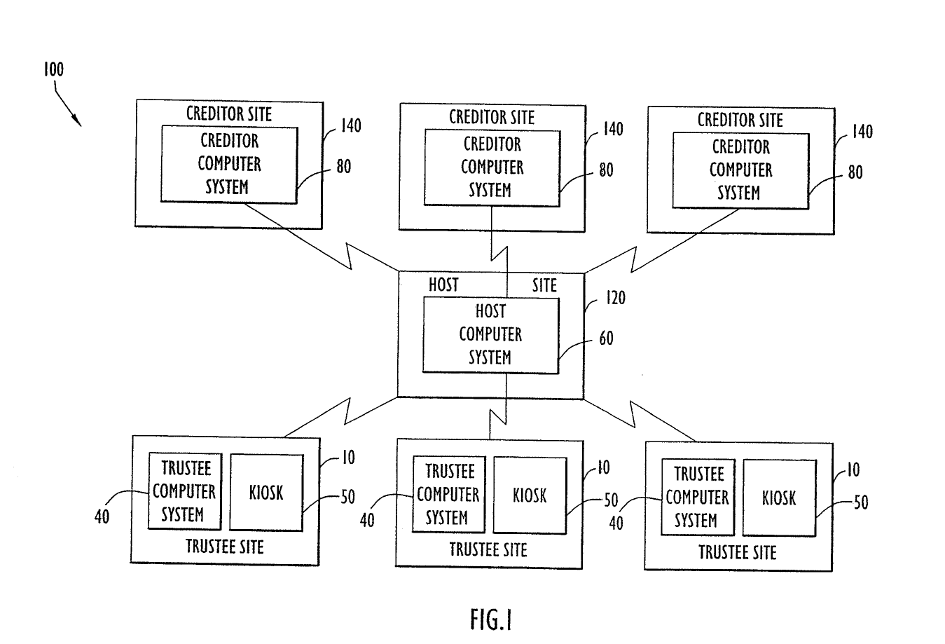

An exemplary system for facilitating customer payments to creditors from a remote site is illustrated in FIG. 1. Specifically, system 100 includes (1) a trustee site 10 (also called an agent site) including a trustee (agent) computer system 40 and a kiosk or creditor transaction device 50; (2) a creditor site 140 including a creditor computer system 80; and (3) a host site 120 (also called a service provider site) including a host computer system (or central database) 60 in communication with at least one of the trustee computer system 40, the kiosk device 50, and the creditor computer system. As shown in FIG. 1, the system typically includes a plurality of creditor sites 140 and a plurality of trustee sites 10 in communication with a single host site 120.

Typically, the service provider arranges for payment to creditors 140 such as utility (i.e., electric, gas, telephone, etc.) or other company sites, and receives processed customer payment transaction information. The service provider further installs the trustee computer systems 40 and the kiosks 50 at the trustee sites 10 (e.g., retail establishments). Finally, the service provider connects the creditor sites 140 and the trustee sites 10 to the host computer system 60. Any communication media may be utilized to connect the host system 60 with the trustee 10 and creditor 140 sites. By way of example, the communication medium may include, DSL connection, cable modem connection, dial-up connection (phone lines), wireless connection (e.g., satellite), and combinations thereof. Information can be sent using transmission methods including, but not limited to, CIE or CTX file format; EDI transmission; MasterCard's RPS process; via a secure FTP; or combinations thereof. Alternatively, host system 60 may send transaction information to the creditor sites 140 in any conventional manner, such as mail, facsimile, or other transport facility.

The trustee computer system 40 is an attended (operated assisted) electronic device adapted to communicate with the host system 60 and the kiosk device 50. The host system 60 is essentially the focal point that receives customer payment transaction information and then processes, stores, and forwards the information to the appropriate creditor and/or trustee systems to enable customer payments to be credited to the corresponding customer accounts. The transaction information is then utilized at respective creditor sites to credit the appropriate customer accounts. Any number of trustees and/or creditors within the communication capabilities of host system 60 may be utilized.

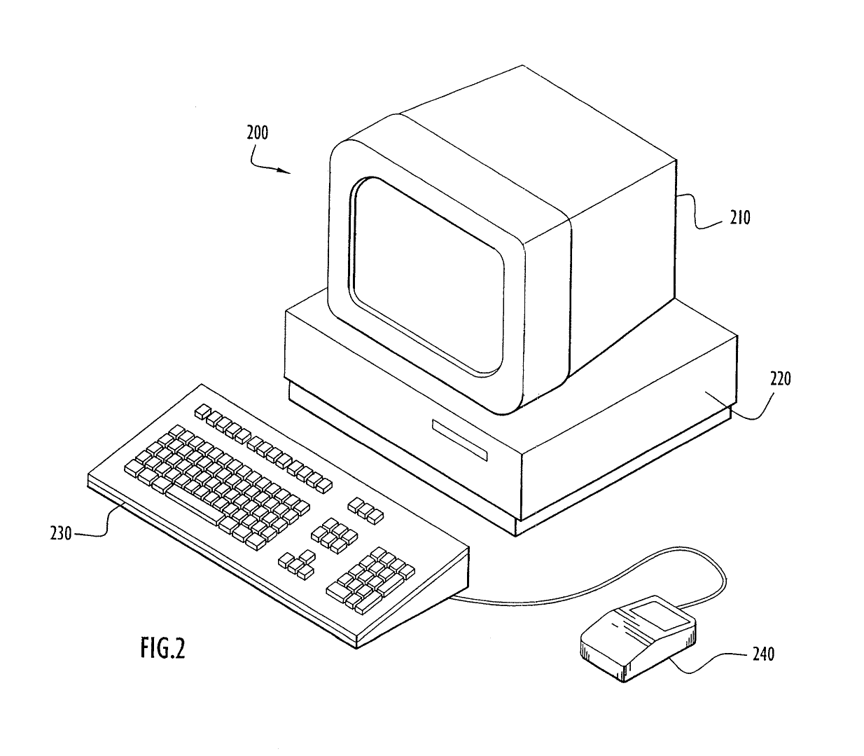

The trustee 40, host 60, and creditor 80 computer systems are preferably implemented by conventional personal computers, or can be larger capacity computers when the data processing requirements necessitate increased processing power. In addition, the trustee system may comprise smaller capacity computer system such as a point of service (POS) device (e.g., a credit card terminal). An exemplary personal computer system for implementing the trustee 40, host 60, and creditor 80 computer systems is illustrated in FIG. 2. Specifically, a computer system 200 may include a conventional IBM-compatible, APPLE-compatible, or other type personal computer preferably equipped with a monitor 210, a base 220 (i.e., including the processor, memory, and internal or external communication devices, ports or modems), a keyboard 230, and a mouse 240. The computer system 200 includes the appropriate software to perform customer payment transaction information processing for any of the trustee 40, host 60, or creditor 60 systems, depending upon the particular utilization of the computer system (i.e., whether the computer system is implemented as a trustee, host or creditor system). The computer system may utilize any of the major platforms or operating systems such as WINDOWS, MACINTOSH, UNIX, DOS or OS2.

The kiosk device 50 (also called a creditor transaction device) is an unattended electronic device capable of receiving input information and generating output information, as well as processing creditor payment information and transactions. The kiosk device 50 is located at the trustee site 10, proximate (e.g., in the same room or building as) the trustee computer system 40. By way of example, the kiosk device 50 may be a computer system in communication with the trustee computer system 40. Specifically, the kiosk device may be linked to the trustee computer system 40, being capable of selectively receiving and/or transmitting information from the trustee system. The kiosk 50 may be directly wired to the trustee computer system 40, or may communicate wirelessly with the trustee computer system. In addition, the kiosk 50 may be adapted to communicate (wired or wirelessly) with the host computer system 60 (i.e., the kiosk uploads and downloads information to/from both the host computer system and the trustee computer system).

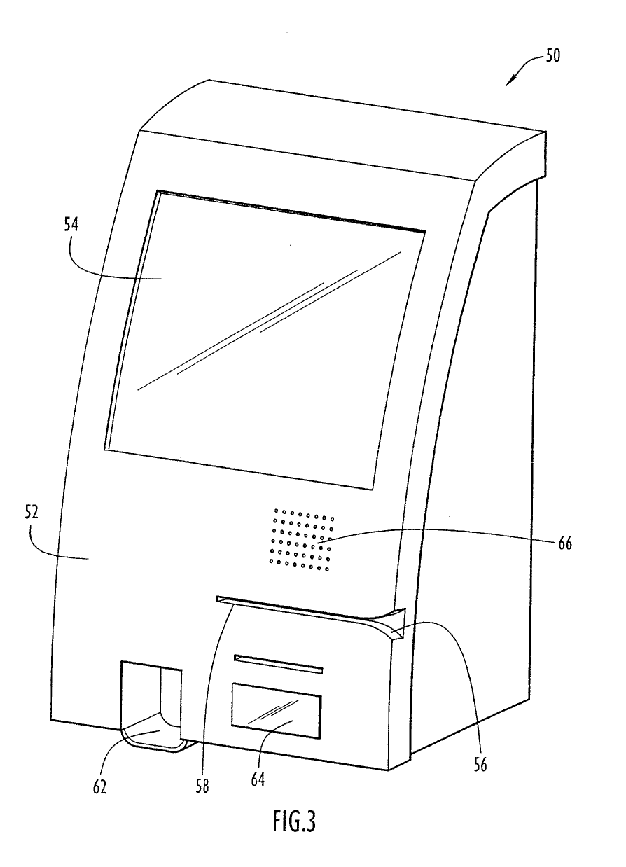

The kiosk 50 is typically a stand-alone device (similar to an ATM device) with software configured to carry out payment transactions. The kiosk 50 may include (1) a display screen; (2) an input device such as a keyboard, a keypad, a trackball, a touch screen, or a voice command unit; (3) a printer; and (4) a scanner (e.g., a card scanner). FIG. 3 illustrates an exemplary kiosk device according to an embodiment of the disclosure. As shown, the kiosk device 50 may include an enclosure 52, a data display 54 (e.g., a surface acoustic wave (SAW) or an LCD touch screen), a magnetic card reader 56, a smart card reader 58, a printed ticket exit 62, an optical reader 64 (e.g., a barcode reader), and/or a speaker 66. The kiosk device 50 may further house a computer controller (e.g., a small form factor Windows (Pentium) based computer) and a ticket printer (e.g., a three inch thermal printer) (neither shown). Since the payment is tendered manually, it is preferred the kiosk device 50 not include a cash acceptor or dispenser.

As discussed above, a service provider typically obtains authorization from various creditors to receive customer payments for the creditors. The service provider (host) computer system 60 and the creditor computer system 80 are typically configured such that the host system 60 communicates with the creditor system 80 in order to forward to the creditor system 80 customer payment transaction information associated with that creditor. Alternatively, the host system 60 may forward the transaction information to the creditor in any conventional manner, such as mail, facsimile or other transport facilities, and, therefore, may not be configured for communication with creditor systems 80. The service provider also solicits trustees (preferably local retail establishments) to process (collect or refund) customer payments. The service provider typically supplies each trustee with the trustee computer system 40 and the kiosk device 50, including the appropriate software and configuration enabling communication with the host system 60, and thus the processing of customer payments received at the respective trustee site. A service fee may be charged to and paid by customers upon utilizing the payment service; moreover, the service fee can be divided in a prearranged manner between the trustee and service provider. For example, depending on the creditor and the arrangement with the service provider, the customer may pay a fee to the trustee, or the fee may come directly from the creditor. Typically, the trustee collects a service fee at the time of manual payment. The fee due the service provider may be electronically drafted to the service provider from the trustee. Similarly, the amount due the creditor may electronically drafted from the service provider to the creditor, or may be paid using conventional payment methods. Normally, the customer pays a fee for each transaction.

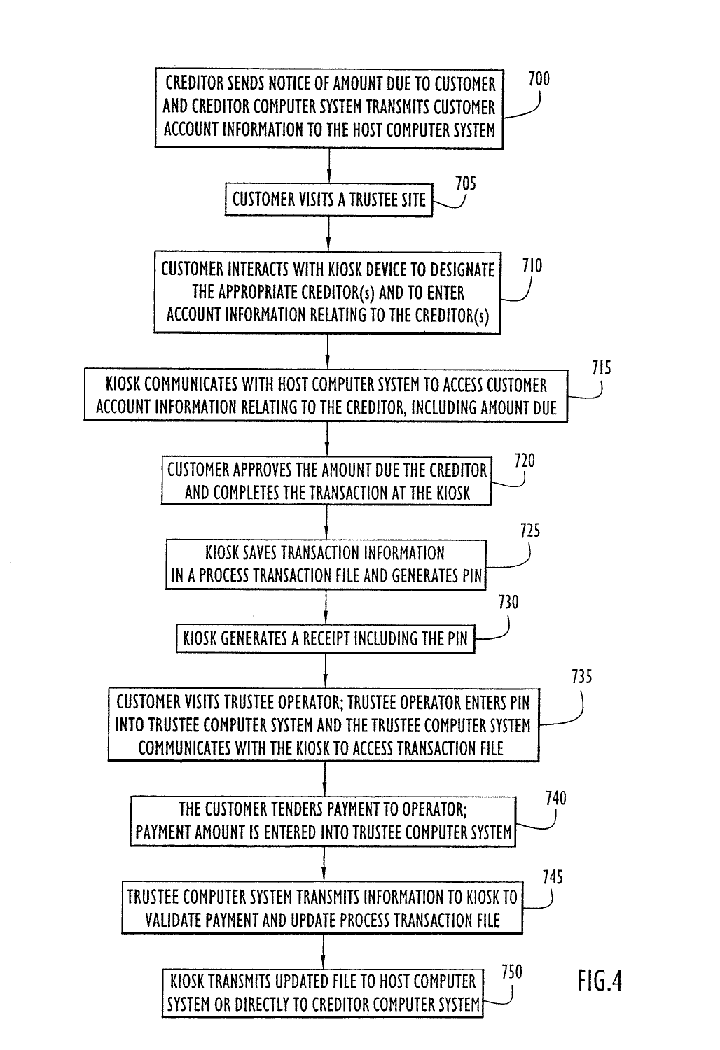

The operation of the system for processing customer payment transactions according to one embodiment of the disclosure is illustrated in FIGS. 1 and 4. Initially, a creditor 140 (Step 700) sends a statement containing account balance information to a customer and requests payment of the balance. In addition, the creditor computer system transmits (downloads) customer account information to the host computer system 60. In response to receiving the creditor statement, the customer visits a trustee site 10 (Step 705). At the trustee site 10, the customer interacts with the kiosk device 50 to designate the creditor, as well as to enter account information relating to the creditor (Step 710). For example, the customer may use interactive software that directs the customer through the payment process to select the creditor and the product that requires payment, allowing the customer to select a creditor from a list displayed by the kiosk 50 and entering the customer account number for that creditor. Alternatively, the customer may enter information than the account number to access the account information (e.g., name, address, etc.). Furthermore, the customer may scan the creditor statement into the kiosk (if the creditor statement contains machine readable indicia). The scanner may be any type of scanner capable of gathering input in any coded or uncoded format, such as a bar code reader or optical character recognition scanner. Similarly, the creditor statement may be generated for compatibility with the particular scanner employed by the trustee system. For example, when a bar code scanner is being employed by the trustee system, the creditor statement includes bar codes in prescribed fields containing the relevant information such that the bar code scanner reads the information directly from the creditor statement into the trustee system. Alternatively, the information may be alphanumeric characters disposed in prescribed fields, and readable by the scanner and computer arrangement.

The kiosk 50, in response to the customer input, communicates with the host computer system 60 to access (download) the customer account information relating to the pertinent creditor, including the amount due. This is indicated at Step 715. Alternatively, the kiosk 50 may communicate directly with the creditor computer system 80. The customer approves the amount due the creditor and completes the transaction at the kiosk 50 (Step 720). Upon completion, the kiosk saves a record of the transaction in a process transaction file, identifying the transaction with, for example, a process/personal identification number (PIN) (Step 725). The kiosk 50 may also generate a printed record, such as a receipt including the PIN (Step 730).

The customer then visits a clerk or operator at the trustee site 10 to tender manual payment. Specifically, the trustee operator enters the PIN into the trustee computer system 40 (Step 735). The trustee computer system 40, in response, communicates with the kiosk 50 to verify the PIN and access (download) the process transaction file. The customer tenders the payment (e.g., via cash) to the trustee operator, who enters the amount into the trustee computer system 40 (Step 740). Once entered, the trustee computer system 40 transmits (uploads) information to the kiosk 50 to validate payment and update the process transaction file (Step 745). At Step 750, the kiosk 50 then transmits the updated file to the host computer system 60 (or if the initial transaction file was sent previously, updates the transaction file with payment validation). Alternatively, the kiosk 50 may communicate directly with the creditor computer system 80 to transmit the updated file. The trustee computer system 40 may then generate a printed record of payment such as a receipt.

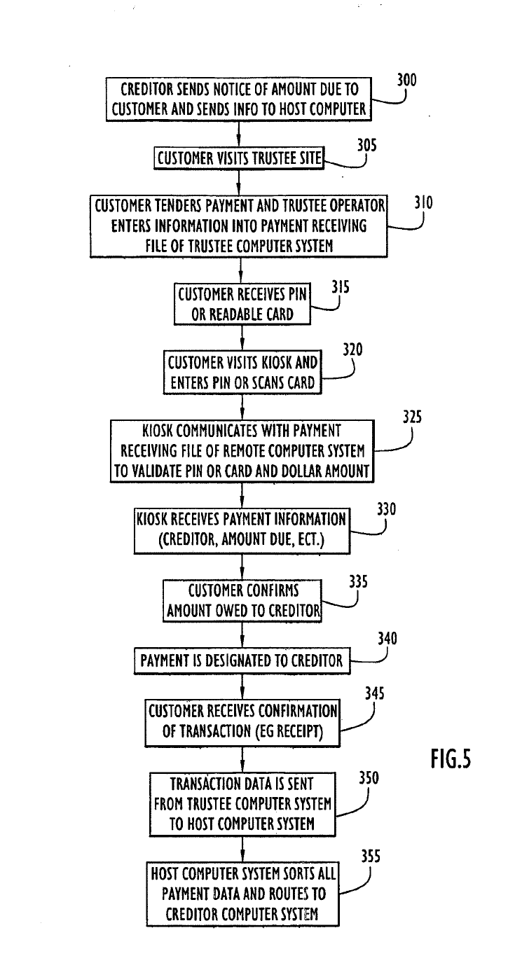

The operation of the system for processing customer payment transactions according to another embodiment of the disclosure is illustrated in FIGS. 1 and 5. FIG. 5 is a procedural flow chart illustrating the manner in which a customer payment transaction is processed according to an embodiment of the disclosure, where a balance is due to a creditor, but initially interacts with the trustee operator prior to interacting with the kiosk 50. As with above embodiment, a creditor 140 (Step 300) sends a statement containing account balance information to a customer and a requests payment of the balance and transmits corresponding customer account information to the host computer system 60. The customer visits a trustee site 10 (Step 305) to manually tender payment (e.g., paying cash) to the trustee operator. The trustee operator enters the payment/transaction information into the trustee computer system 40, which processes and maintains the information in a payment receiving area (i.e., a payment transaction file). This is indicated at Step 310. Once the payment is tendered and the transaction information processed, the trustee system 40 generates a payment verification record for that customer transaction (Step 315). The record may be a personal identification number (PIN). Alternatively, the system 40 could generate a portable element capable of storing information such as a magnetic card (e.g., at ATM card) or other computer/scanner readable element. The operator provides the payment verification record (i.e., PIN/card) to the customer. At Step 320, the customer visits the kiosk device 50 that is associated with and located proximate to the trustee computer system 40. As explained above, the kiosk device 50 is typically located at the same site where the payment is made (i.e., at the trustee site 10).

The customer initially interacts with kiosk 50 by authorizing the payment process. Specifically, the customer enters the assigned PIN (or has the kiosk 50 scan the readable element). The kiosk device 50 communicates with the payment receiving area of the trustee computer system 40 to validate the PIN (or the readable element) and identify the dollar amount present in the account (i.e., the dollar amount tendered to the trustee/operator) (Step 325).

At Step 330, the kiosk 50 communicates with the host computer system 60 to access creditor payment information relating to the customer. The kiosk 50 may include interactive software that directs the customer through the payment process to select the creditor and the product that requires payment. For example, the customer may initiate the “Customer Bill-Pay” function wherein the kiosk device 50 displays a customer payment screen including fields to receive the customer name, customer identification number, and/or a customer address (i.e., street, city, state and zip code wherein the screen includes fields for receiving such information). In addition, screen may include a listing of creditors from which a specific creditor (e.g., utility or other company) may be chosen. Once chosen, the customer may enter the appropriate customer account number and the amount to be paid to the creditor. The particular layout of the screens for input of information is not particularly limited, and may include those disclosed by U.S. Pat. No. 6,611,818 (Mersky et al), incorporated herein by reference in its entirety. The types of products are not limited. By way of example, it may include bill payment (creditor or utility bills), wire transfers, or prepaid products such as gift cards, phone cards, or wireless phones.

Alternatively, if the creditor statement includes machine readable information, the customer may have the bill read (e.g., by inserting the bill into a reader/scanner) to retrieve payment information. Specifically, customer payment processing may be performed in substantially the same manner described above except that the customer and other related information may be entered into kiosk device 50 utilizing a scanner. The scanner reads the relevant customer information from the creditor statement, thereby facilitating automatic entry of customer and other related information (e.g., amount due to the creditor, account numbers, creditor name, customer name and address, etc.) into the kiosk device 50 (and thus the trustee computer system 40). The scanner may be any type of scanner capable of gathering input in any coded or uncoded format, such as a bar code reader or optical character recognition scanner. Similarly, the creditor statement may be generated for compatibility with the particular scanner employed by the trustee system. For example, when a bar code scanner is being employed by the trustee system, the creditor statement includes bar codes in prescribed fields containing the relevant information such that the bar code scanner reads the information directly from the creditor statement into the trustee system. Alternatively, the information may be alphanumeric characters disposed in prescribed fields, and readable by the scanner and computer arrangement.

The kiosk software displays the amount owed. Optionally, the computer system of kiosk device 50 may provide the customer with an opportunity to confirm the amount due (to ensure its accuracy) (Step 335). The customer approves the payment, designating all or part of the amount indicated in the payment transaction file be applied to a specific creditor balance. At Step 340, the payment transaction is completed, with the transaction information being communicated to the trustee computer system 40 (that the appropriate amount may be deducted from the payment transaction file). The customer then receives confirmation that the transaction is completed (i.e., that the bill has been paid) at Step 345. As discussed above, the kiosk 50 may include a printer that generates a receipt recording the transaction and confirming that payment was tendered. The type of receipt is not limited, an may include those disclosed in U.S. Pat. No. 6,611,818 (Mersky et al), incorporated herein by reference in its entirety.

Once the creditor transaction is processed, the kiosk 50 communicates with the trustee computer system 40, transmitting the transaction data to the trustee computer system 40 to update account information (i.e., that a balance has been applied to a product account). The transaction data is transmitted (typically in real time) from the trustee computer system 40 to the host computer system 60 (via internet, dial-up, etc) (Step 350) (discussed in greater detail below). Alternatively, the kiosk 50 may transmit the information directly to the host computer system 60. Finally, at Step 355, the host computer 60 sorts all incoming payments and routes them to the appropriate creditor 140. Any or all the steps of this process may then be repeated as necessary with remaining products and account balances.

In an alternate embodiment, kiosk device 50 may be used to disburse a payment to a customer. Initially, a creditor 140 sends a statement to a customer, indicating an amount is owed to the customer. Accordingly, the creditor system 80 transmits information to the host computer system 60, indicating an amount is owed to a customer. The host computer system 60, in turn, communicates this information to either the trustee computer systems 40 the kiosk 50, or both. Each system stores the information in a payment disbursement file. The customer visits a trustee site 10 and interacts with the kiosk 50, entering identifying information (e.g., name, social security number, etc.), or using the kiosk scanner to read the payment notice. The kiosk 50 communicates with the trustee computer system 40 or the host computer system 60 to validate the amount due the customer (i.e., to access the customer record in the payment disbursement file). The software may further verify the identity of the customer (e.g., via security questions such as date of birth, mother's maiden name, etc). Once the identity of the customer and the amount owed the customer is validated, the kiosk 50 provides a disbursement verification record. The record may include a receipt printed by the kiosk 50 that indicates account information, for example, a PIN number and the payment amount. Alternatively, the kiosk may generate a machine readable element (e.g., a receipt with a bar code or a card). The kiosk 50 stores this information, or sends it to the trustee computer system 40 for storage in the payment disbursement file. The customer may then take the payment verification record to an operator located at the trustee computer system 40. The trustee operator processes the record using the trustee computer system 40 and pays the amount due the customer. Specifically, the operator may verify the amount due by supplying the identification number printed on the receipt generated by the kiosk 50, or by scanning the readable card or bar code. During the verification, the trustee computer system 40 extracts the appropriate information from a payment disbursement file. The operator may further require proof of customer identification, etc. Once processed, the operator may provide a receipt indicating that payment has been received. The trustee computer system 40 then transmits the payment information to either the host computer 60 and/or the kiosk device (which, in turn, transmits the information to the host computer system). The host processor 60 then processes the information and directs it to the appropriate creditor system 80.

The trustee system 40 and/or kiosk 50 may repeatedly process customer payments as described above. At the completion of each payment transaction, the trustee computer system 40 transmits the transaction (a payment received or disbursed) to the host computer system 80. Once the trustee system 40 or kiosk 50 establish a connection to the host system 60, the trustee system 40 transfers a file containing the transaction information.

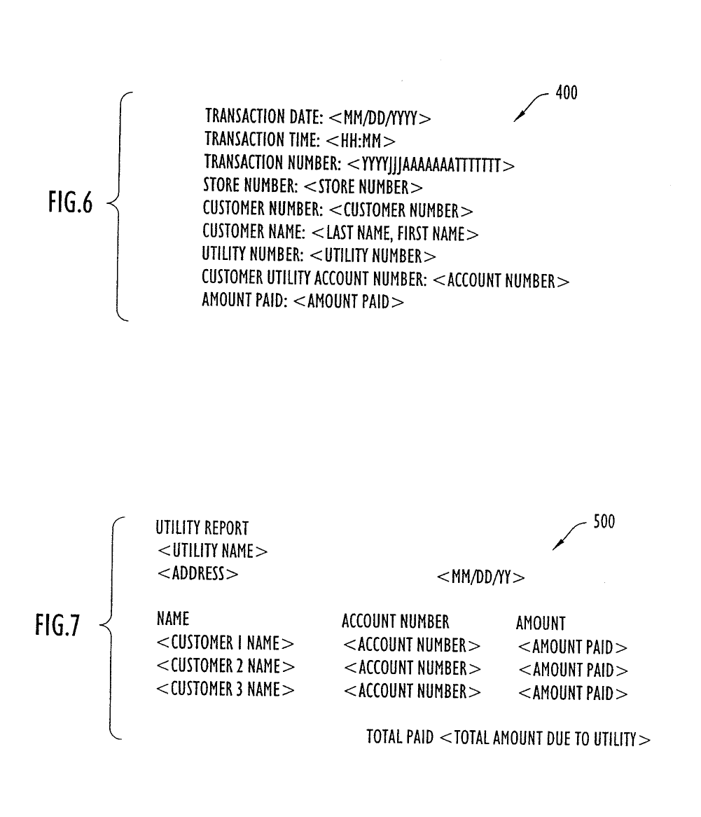

The transaction file includes a plurality of records, with each record having information pertaining to a particular transaction as illustrated, by way of example, in FIG. 6. The text delineated by brackets ‘< >’ in the Figure indicates the type of information appearing in a record field. Specifically, a record 400 contains information relating to the transaction date (e.g., in an MM/DD/YYYY format as described above) and time (e.g., in an HH:MM format wherein H indicates the hour and M indicates the minute), the transaction number (e.g., in a YYYYJJJAAAAAAATTTTTTT format wherein Y indicates the year, J indicates the day of the year, A indicates the trustee number and T indicates the transaction number), the trustee number, the customer name (e.g., last name, first name), the customer identification number described above, the creditor number (i.e., a number identifying a particular creditor), the customer account number and the amount paid by the customer.

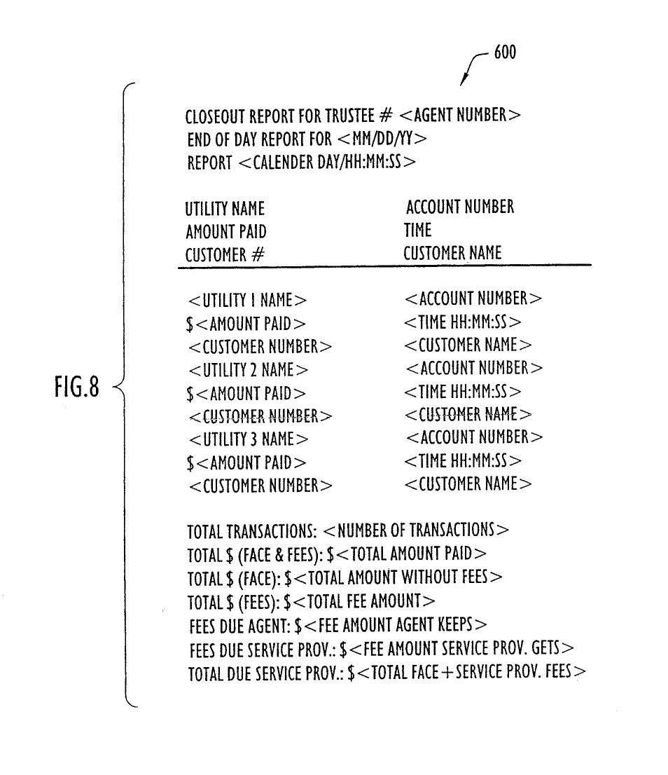

Upon receipt of the payment transaction information from each trustee system, the host system may generate a creditor report for each individual creditor as illustrated, by way of example, in FIG. 7. The text delineated by brackets ‘< >’ in the Figure indicates the type of information appearing in the report field as described above. Specifically, the host system 60 receives a transaction file from each trustee system 40 as described above. The host system 60 examines each record 400 (FIG. 5) in the file and retrieves the creditor, customer name, customer account, and amount paid information. The host system 40 then sorts the retrieved information based on the particular creditor such that all transactions related to a specific creditor are grouped together to form an individual report. The individual reports for the respective creditors affiliated with the service provider may contain information relating to the creditor name and address, the date (e.g., in an MM/DD/YY format as described above) of the report, a table including the customer transactions for the creditor, and the total amount due to the creditor. The table may include column headings indicating the customer name, customer account number, and amount paid, while each table row indicates a customer payment and specifies the amount a particular customer paid to the creditor. The host system 60 may automatically calculates the total amount due to the creditor and places the amount in the creditor report below the table. When a report is generated by the host system 60 for each creditor affiliated with the service provider, the reports are sent to the appropriate creditors. The reports are typically sent to the creditors via communications between host system 60 and creditor systems 80. However, the host system 80 may send the reports to the creditors in any conventional manner, such as mail, facsimile or other transport facilities. The service provider subsequently remits payment to the respective creditors in accordance with the creditor report totals via check, electronic fund transfer, or in any other agreed upon conventional manner.

After the creditor reports 500 are generated, the host system 60 may determine whether or not a predetermined reporting time (e.g., the end of the day) has arrived. When the host system determines that the end of the day has arrived, the host system may generate a closeout report 600 as illustrated by way of example in FIG. 8. The text delineated by brackets ‘< >’ in the Figure indicates the type of information appearing in the report field as described above. The closeout report 600 is generated based on the information in the transaction files received from each trustee system 40. Specifically, the closeout report 600 includes information related to each respective trustee site 10. The information included in the report for each respective trustee site is related to the trustee number, the day for which the report is generated (e.g., in an MM/DD/YY date format as described above), the date (e.g., the calendar day) and time (e.g., in an HH:MM:SS format described above) that the report is generated, and for each transaction at the respective trustee site, the creditor name, the customer account number, the amount paid, the time (e.g., in an HH:MM:SS format described above) of the transaction, the customer name and the customer identification number. In addition, the host system 60 calculates totals pertaining to the payment transactions based on the relevant information in the transaction files, wherein the closeout report 600 further includes for each respective trustee site 10 the total number of transactions, the total amount paid by customers (and/or to customers) including service fees (i.e., total of face amounts and service fees), the total amount paid by customers excluding service fees (i.e., the total face amount), the total amount of service fees (e.g., the service fees due to the trustee and service provider), and the total amount due to the service provider (i.e., amount of customer payments and the portion of the fees due to the service provider). In accordance with the closeout reports, the service provider deducts or remits payment from/to the trustees' bank accounts via the host computer system 60 or other device, or receives/remits payments from the trustees in any other conventional pre-arranged manner.

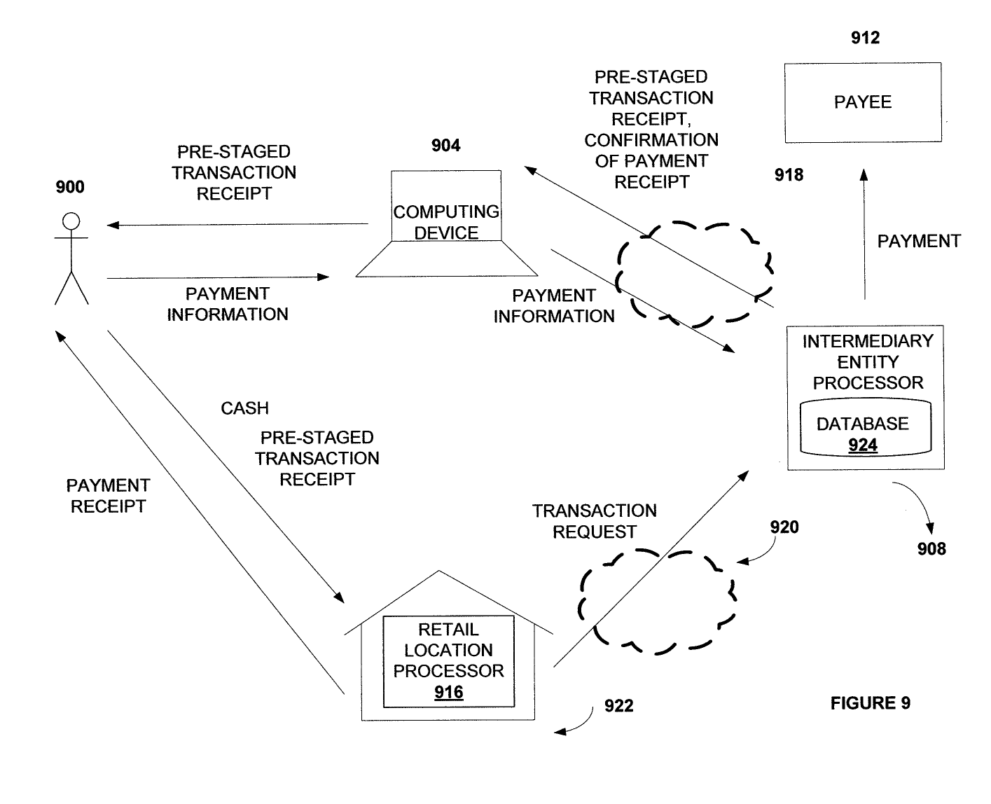

Referring now to FIG. 9, a user 900 interacts with a computing device 904 to provide payment information. Payment information includes any of the following, but is not limited to: a payee name, a payee address, a payment amount, a payee telephone number, a payor address, a payee email address, a payor email address, payor telephone number, payor mobile number, an account number, account balance and balance due. As is understood by one of ordinary skill in the art, payment information is any information that is used to identify, specify or detail a financial transaction between parties. In one embodiment, payment information is originally sent from a payee 912 to the user 900, interchangeably referred to hereinafter as the payor, in the form of a credit card bill, account statement, or other financial statement. The computing device 904 sends the payment information to an intermediary entity processor 908 via a network 918, which returns a pre-staged transaction receipt to the computing device 904. The pre-staged transaction receipt may be any of the following, but is not limited to: a bar code, an RFID tag, an alphanumeric character string, a graphic file, a magnetic strip and a hologram. As will be understood by one of ordinary skill in the art, the pre-staged transaction receipt is any medium that represents, codes or encodes a unique identifier assigned to a pre-staged financial transaction.

It is noted that the computing device 904 is any device capable of receiving and transmitting information. The computing device 904 may include any of the following, but is not limited to: a personal computer (PC), a personal digital assistant (PDA), a laptop computer, a tablet PC, a set-top box, a telephone, a pager and a mobile phone. In an exemplary embodiment, the pre-staged financial transaction receipt is a bar code that is printed via the computing device 904. In another embodiment, the pre-staged transaction receipt is electronically sent to the computing device 904 in the body of an email or as an attachment to the email. In yet another embodiment, the pre-staged transaction receipt is sent as a short messaging system (SMS) message or a text message. As will be understood by one of ordinary skill in the art, the pre-staged transaction receipt is any message generated and transmitted by any message delivery system.

As will also be understood by one of ordinary skill in the art, if the pre-staged transaction receipt is provided, for example, via a set-top box or a telephone, the pre-staged transaction receipt is printed, reproduced, or transcribed into a hardcopy format for the user 900 to provide at a retail location 922. In an exemplary embodiment, when the pre-staged transaction receipt is not printed or otherwise reproduced in a hardcopy format, the pre-staged transaction receipt is stored on a device (e.g., mobile phone, pager, laptop PC) that is scanned at the retail location 922. As will be understood by one of ordinary skill in the art, a retail location is not limited to a location where items are purchased and sold. Rather, a retail location is any public location.

The pre-staged transaction receipt is provided in real-time or near real-time via communication channels of a network 918. It is noted that the network 918 and a network 920 each are one more networks that may include any combination of the following networks, but are not limited to: the Internet, telecommunications networks, data networks, wireless networks, ad hoc networks, satellite networks, wide area networks, local area networks and virtual private networks. The communication channels are any of twisted copper pair, coaxial cable, optical fiber, wireless link, or other medium capable of transmitting a signal.

The user 900 manually tenders payment (e.g., cash, debit account, debit card, check and the like) in the amount specified by the payment information to a human or automated cashier at the retail location 922 at which a retail location processor 916 is located. In one embodiment, the cashier is a self-service checkout kiosk. In another embodiment, the cashier is an employee of the retail location 922. In yet another embodiment, the user 900 enters the payment information via computing device 904 at the retail location 922. That is, the user 900, the computing device 904 and the retail location 922 are all in the same geographic area and the computing device 904 and the retail location processor 916 may be in close proximity to each other. In still another embodiment, the user 900 and the computing device 904 are at a location that is geographically distributed form the retail location 922 and consequently, distributed from the retail location processor 916. As will be understood by one of ordinary skill in the art, any members of a subset of the user 900, the retail location 922, the computing device 904, the retail location processor 916, and the intermediary entity processor 908 may be geographically distributed from each other member in the subset. In yet another embodiment, any members of a subset of the user 900, the retail location 922, the computing device 904, the retail location processor 916, and the intermediary entity processor 908 may be located at a common geographic location.

To manually tender payment, the user 900 visits the retail location 922 and physically provides payment to the above-described cashier. The retail location 922 is any public or semi-public location that people, in addition to the user 900, are permitted to access. For example, the retail location 922 may be any of, but is not limited to: an airport, a hotel lobby, a restaurant, a clothing store, a pharmacy, a convenience store, a gas station, a nightclub, a hospital and a parking garage. As will be understood by one of ordinary skill in the art, the retail location 922 is any location at which the user can provide payment, and that is not the user's residence. The user 900 also provides the pre-staged transaction receipt in the manner noted above. The retail location processor 916 at the retail location 922 scans the pre-staged transaction receipt to obtain information encoded on the pre-staged transaction receipt. In one embodiment, scanning equipment includes an optical character recognition device. In another embodiment, scanning equipment is a bar code reader. The scanning equipment is able to read, e.g., the RFID tag, hologram, magnetic strip, alphanumeric character string or graphic file that is the pre-staged transaction receipt. As will be understood by one of ordinary skill in the art, the scanning equipment at the retail location processor 916 is any equipment capable of obtaining information about the financial transaction represented, coded or encoded by the pre-staged transaction receipt.

The retail location processor 916 sends a transaction request to the intermediary entity processor 908 that includes the unique identifier assigned to the pre-staged financial transaction. As discussed above, the retail location processor 916 obtains the unique identifier by scanning or reading the pre-staged transaction receipt. The transaction request is sent electronically over communication channels comprising the network 920, as explained above. The transaction request includes information related to the unique identifier assigned to the pre-staged financial transaction. In one embodiment, the intermediary entity processor 908 is geographically distributed from the retail location 922, and consequently the retail location processor 916. In another embodiment, the intermediary entity processor 908 are at the retail location 922. That is, the intermediary entity processor 908 may be in close proximity to the retail location processor 916.

The intermediary entity processor 908 matches the transaction request with information for a pre-staged financial transaction stored in a database 924. Subsequently, the intermediary entity processor 908 sends a payment to the payee 912 specified by the payment amount initially entered by the user 900 as payment information and provided by the user 900 at the retail location 922. The retail location processor 916 provides funds to the intermediary entity processor 908 after sending the transaction request.

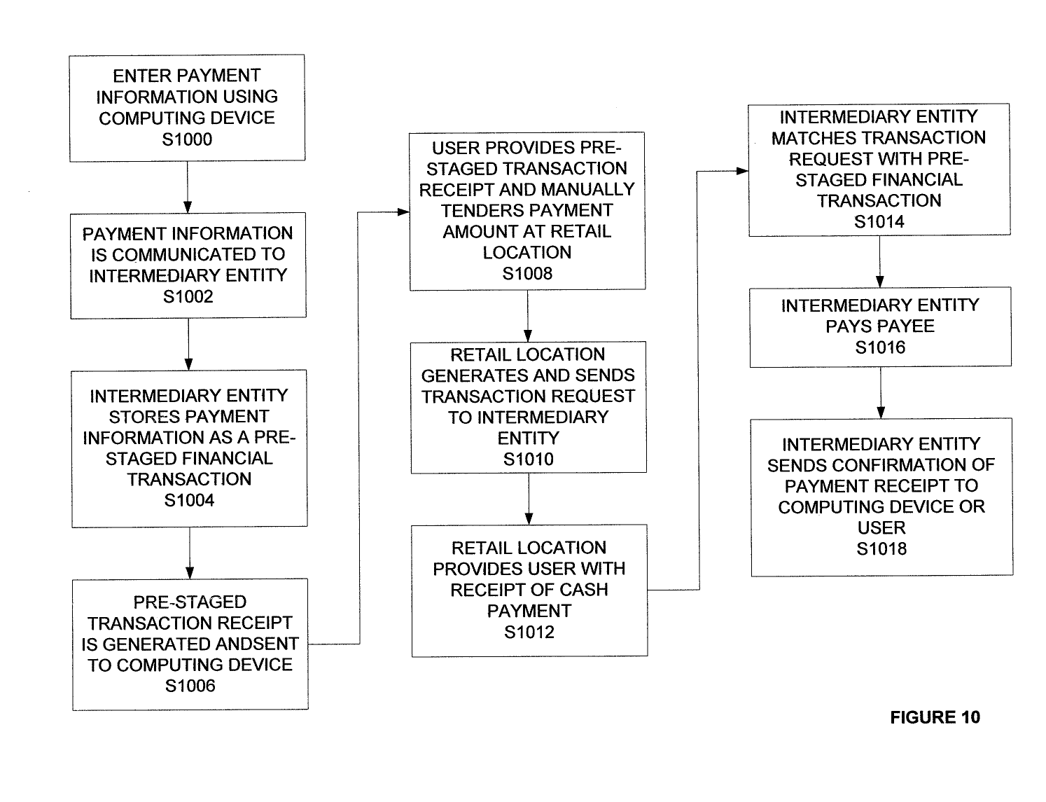

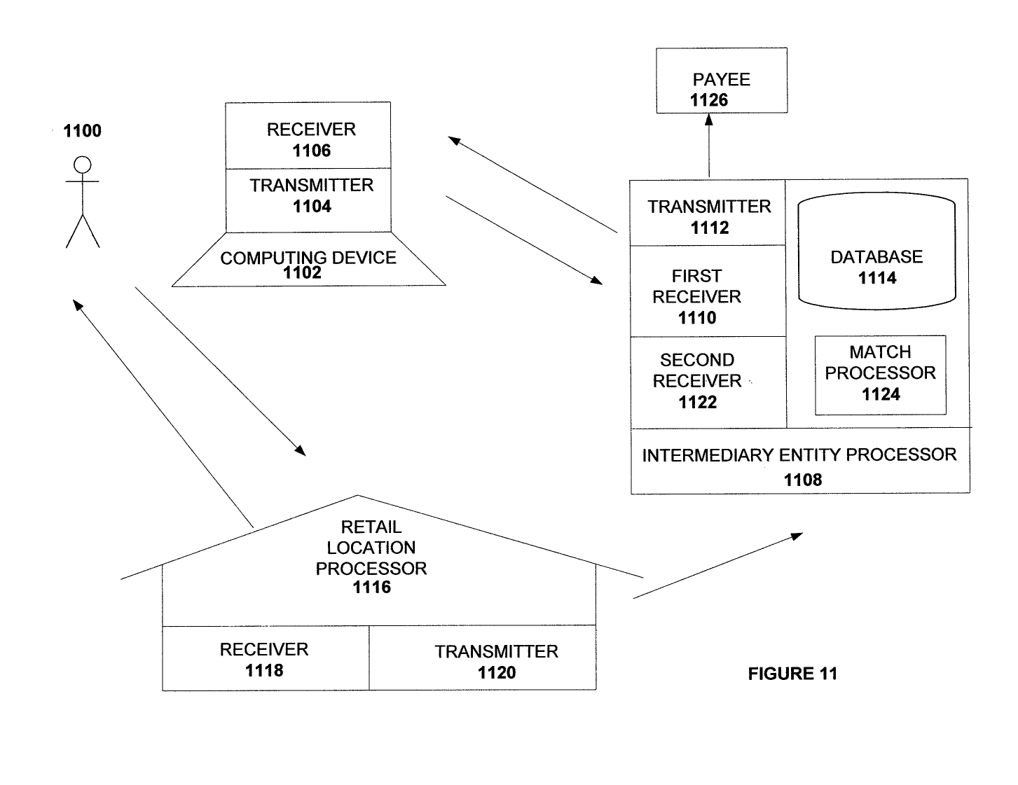

Referring now to FIG. 10, in step S1000, payment information is entered using a computing device. In step S1002, the payment information is communicated to the intermediary entity. In step S1004, the intermediary entity stores the payment information as a pre-staged financial transaction in a database. A pre-staged financial transaction receipt is generated and sent to the computing device in step S1006. In step S1008, the user provides the pre-staged transaction receipt and manually tenders a payment amount at a retail location. A retail location processor at a retail location scans or reads the pre-staged transaction receipt to obtain a unique identifier corresponding to a pre-staged financial transaction, and to generate a transaction request, in step S1010. Also in step S1010 the retail location sends the transaction request to the intermediary entity.

The retail location optionally provides the user with a receipt for the payment in step S1012. In step S1014, the intermediary entity matches the transaction request with a pre-staged financial transaction stored in the database. The intermediary entity sends the payee the payment amount in step S1016. In step S1018, the intermediary entity sends a confirmation of payment receipt to the computing device. The confirmation of payment receipt may be sent electronically, via postal mail or via any other method of communication. The confirmation of payment receipt may be a physical receipt, an email, a text message, an SMS message, or any other message deliverable via a message delivery system.

In FIG. 11, components of a computing device 1102, a retail location processor 1116 and an intermediary entity processor 1108 are shown. As described above, the computing device may include any of the following, but is not limited to: a personal computer (PC), a personal digital assistant, a laptop computer, a tablet PC, a set-top box, a pager, and a mobile phone. The computing device is located anywhere a user desires to interact with the computing device. That is, in one embodiment the computing device is a home computer that the user interacts with at home. In another embodiment, the computing device is a mobile phone that the user interacts with while at work. It should be understood by one of ordinary skill in the art that the computing device is one or a combination of devices capable of receiving and transmitting data and/or information. The computing device 1102 includes a transmitter 1104 and a receiver 1106 via which data and information are communicated. The transmitter 1104 and the receiver 1106 are either wireless or wireline interfaces. In one embodiment, either or both the transmitter 1104 and the receiver 1106 are infrared transmitters. The transmitter 1104 sends and the receiver 1106 receives information over communication channels to and from the intermediary entity processor 1108.

The intermediary entity processor 1108 includes a transmitter 1112, a first receiver 1110 and a second receiver 1122. Further, the intermediary entity processor 1108 includes a match processor 1124 and a database 1114. The first receiver 1110 receives information sent by the computing device 1102 and the second receiver 1122 receives information sent by the retail location processor 1116. In one embodiment, the first receiver 1110 and the second receiver 1122 are implemented as a single receiver or each interface to both the computing device 1102 and the retail location processor 1116. The database 1114 stores payment information entered by the user 1100 via the computing device 1102 as a pre-staged financial transaction. In one embodiment, the database 1114 stores a unique transaction identifier in relation with the payment information entered by the user. A match processor 1124 matches a transaction identifier in a transaction request from the retail location processor 1116 with the transaction identifier stored in the pre-staged financial transaction database 1114. From this information, the match process 1124 is able to obtain pre-staged financial transaction including the payment information. As discussed above, the payment information indicates which payee 1126 is to be paid and how much the payee 1126 is to be paid. The retail location processor 1116 also includes a receiver 1118 and a transmitter 1120 to send and receive data over communication channels of one or more network.

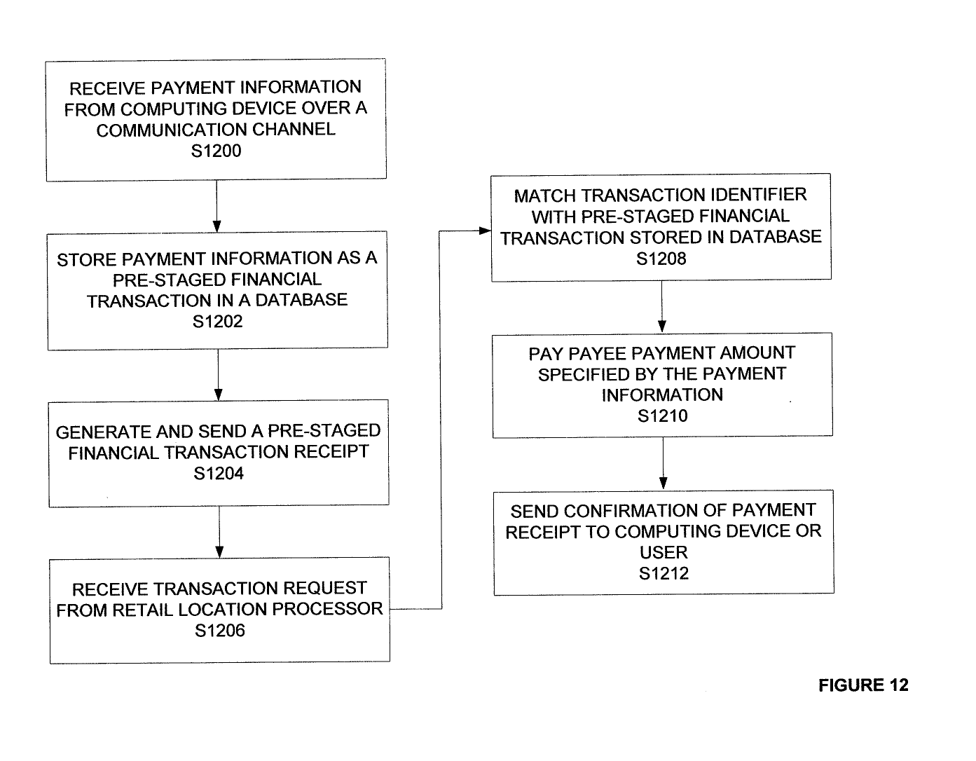

Referring now to FIG. 12, a process flow diagram illustrating the operation of the intermediary entity and intermediary entity processor is shown. In step S1200, payment information is received from a computing device over communication channels of at least one network. In step S1202, the payment information is stored with a transaction identifier as a pre-staged financial transaction in a database. In step S1204, a pre-staged financial transaction receipt generated and sent to a user via the communication channels to the computing device. In step S1206, a transaction request is received from a retail location processor. As discussed above, the transaction request includes the transaction identifier and is sent in response to receiving a pre-staged transaction receipt from the user. As discussed above, the user also manually tenders a payment amount specified by the payment information via the retail location processor at the retail location. In step S1208, the transaction identifier from the transaction request is matched with the pre-staged financial transaction stored in the database and step S1210, a payee is paid the payment amount specified in the payment information. In step S1212, a confirmation of payment receipt is optionally sent to the user and/or the computing device.

It will be appreciated that the embodiments described above and illustrated in the drawings represent only a few of the many way of implementing the customer payment system of the present disclosure. For example, the kiosk 50, in addition to communicating with the trustee computer system 40, may also communicate directly with the host computer system 60. In addition, the transaction information may be transmitted (uploaded/downloaded) from one computer system (creditor, trustee, and host) to another at any time throughout the process. In certain configurations, the kiosk device 50 may transmit and access information directly from the creditor computer system 80. Similarly, information may be stored in any of the kiosk device 50, the trustee system 40, and/or the host system 60. In addition, an intermediate processor may be utilized wherein the intermediate processor (e.g., a Mastercard RPPS) takes payment data from the host computer system 60 and transmits the data to the creditor computer system 80.

The time at which the transaction is transmitted is not particularly limited, and can be transmitted at any point during the payment transaction. For example, date may be transmitted in real time. In addition, date may be transmitted at predetermined intervals (e.g., on an hourly or daily basis), sending updates as warranted. In addition, in one embodiment, trustee system 40 and/or kiosk 50 may determine whether or not the transaction information has been transmitted to the host system 60 within a predetermined time interval. In the event that the trustee system 40 and/or kiosk 50 determines that the information has not been transferred to the host system, the trustee system and/or kiosk may automatically disable itself, precluding it from processing further customer payment transactions until the appropriate system is reset.

Additionally, the number of bills paid during a transaction is not limited. That is, the customer can tender payment for multiple bills during a single transaction. Similarly, during a kiosk interaction, the customer could designate payment to more than one creditor. The kiosk device 50 may tabulate the entire amount owed to various creditors, indicating a total amount due to the trustee operator. The method of payment, though typically cash, may also include check, money order, credit cards, etc. Additionally, the customer may include an electronic debit account with the trustee, wherein the account is deducted automatically by designation of the customer.

The computer systems may be implemented by any type of computer system (e.g., personal computer, mini or microcomputer, microprocessor, main frame, etc.) or processor and monitor capable of processing and communicating transaction information. Further, the host system may be implemented by a mainframe having terminals located at the trustee sites wherein the mainframe does all the processing of payment information on-line as the information is entered at the terminals, the processing being carried out in substantially the same manner described above. The creditor computer systems may also be mainframe computers utilized by the creditor to process customer accounts wherein the creditor reports may be sent to the mainframe from the host system for automatic updating of customer accounts. Alternatively, the creditor computer system may be a personal or other computer system for receiving the creditor report from the host system, wherein the receiving computer may either transmit the report to a creditor processing system for updating customer accounts, or print the report for data entry into the creditor processing system. The computer system screens may be arranged in any fashion and contain any desired information. Further, the screens may be implemented by windows, graphical user interfaces, line prompting, or any other data entry and display techniques. Moreover, any keystroke or input device may be utilized to initiate the various screen functions (e.g., mouse, voice, etc.). Communications between the computer systems may be accomplished by any techniques capable of transmission and reception of the transaction information. The creditor reports may be sent to the creditor from the service provider site via the creditor and host computer systems or any other transport method, such as facsimile (e.g., host system to facsimile or faxing a hard copy of the report), or mailing or transporting hardcopy of the report to the creditor.

The software for the present disclosure may be implemented in any of a number of computer programming languages. It is to be understood that one of ordinary skill in the computer arts can develop the software based on the foregoing description and flow charts.

The trustee systems may employ any type of scanner for reading information directly from a billing statement or other form wherein the creditor billing statements or other forms may be printed or encoded in any manner capable of being read by any type of scanner utilized by the trustee system for system data entry. The transaction information may be stored in a database, file, data structure or any other software construct capable of maintaining transaction information.

From the foregoing description it will be appreciated that disclosure makes available a novel method and apparatus for facilitating customer payments to creditors from a remote site wherein the system facilitates customer payments in any payment form (e.g., cash, credit card, etc.) to various creditors from a local remote site, preferably a retail establishment, by interacting with a service provider to inform the creditor of the customer payments at the remote site and enable the creditor to update corresponding customer accounts.

Having described preferred embodiments of a new and improved method and apparatus for facilitating customer payments to creditors from a remote site, it is believed that other modifications, variations, and changes will be suggested to those skilled in the art in view of the teachings set forth herein. It is therefore to be understood that all such variations, modifications, and changes are believed to fall within the scope of the present disclosure as defined in the appended claims.

What is claimed is:

1. A method of pre-staging a financial transaction, comprising:
sending payment information entered using a device at a user location, via an electronic communication channel, for pre-staging the financial transaction;
receiving a pre-staged transaction receipt corresponding to the financial transaction from an intermediary entity implemented on at least one processor;
manually tendering a payment amount, the payment amount corresponding to the payment information, and the pre-staged transaction receipt at a retail location; and
paying a payee the payment amount, the payee being specified in the payment information, based on matching a transaction request from the retail location with the pre-staged financial transaction.

2. The method according to claim 1,
wherein the financial transaction is pre-staged with the intermediary entity.

3. The method according to claim 1,
wherein the payment information comprises: a payee name, a payee address, the payment amount, a payee telephone number, a payee email address, a payor address, a payor email address, payor telephone number, payor mobile number, an account number, an account balance and a balance due.

4. The method according to claim 1,
wherein the retail location and the user location are geographically distinct from each other.

5. The method according to claim 1,
wherein the pre-staged transaction receipt comprises at least one of: a radio frequency identifier (RFID) tag, a bar code, a magnetic strip, a graphic file, a hologram and an alphanumeric character string.

6. The method according to claim 1,
wherein the intermediary entity matches the transaction request from the retail location with the pre-staged financial transaction.

7. The method according to claim 1,
wherein the retail location and the user location are situated at a common geographic location.

8. The method according to claim 1, further comprising:
receiving a payment receipt from the retail location.

9. The method according to claim 3, further comprising:
receiving a confirmation of payment via at least one of: the payor email address, the payor address, the payor telephone number and the payor mobile number.

10. The method according to claim 1,
wherein a payor enters the payment information.

11. The method according to claim 10,
wherein the device comprises at least one of: a personal computing device, a personal digital assistant (PDA), a mobile device and a set-top box.

12. The method according to claim 1,
wherein the payor enters the payment information to a website for the intermediary entity.

13. The method according to claim 1,
wherein the pre-staged transaction receipt is sent to at least one of the device, a printer, a personal digital assistant (PDA), a mobile device, a set-top box and a pager, and
wherein the device comprises computing device.

14. The method according to claim 1,
wherein the intermediary entity stores the pre-staged financial transaction, and
wherein the intermediary entity receives the transaction request from the retail location.

15. A system of pre-staging a financial transaction, comprising:
an intermediary entity processor which receives payment information that pre-stages the financial transaction from a device over an electronic communication channel, the intermediary entity processor sending a pre-staged transaction receipt to the computing device; and
a retail processor which processes the pre-staged transaction receipt and a payment amount specified by the payment information, the payment amount and the pre-staged transaction receipt being manually tendered by a user at a retail location, the retail processor sending a transaction request to the intermediary entity processor,
wherein the intermediary entity processor pays a payee the payment amount, based on matching the transaction request with the pre-staged financial transaction.

16. The system according to claim 15,
wherein the financial transaction is pre-staged by an intermediary entity hosting the intermediary entity processor, and
wherein the pre-staged transaction receipt corresponding to the financial transaction is generated by and received from the intermediary entity.

17. The system according to claim 15,
wherein the payment information comprises: a payee name, a payee address, the payment amount, a payee telephone number, a payee email address, a payor address, a payor email address, a payor telephone number, a payor mobile number, an account number, an account balance and a balance due.

18. The system according to claim 15,
wherein the retail processor and the intermediary processor are located at a shared geographic location.

19. The system according to claim 15,
wherein the pre-staged transaction receipt comprises at least one of: a radio frequency identifier (RFID) tag, a bar code, a magnetic strip, a graphic file, a hologram and an alphanumeric character string.

20. The system according to claim 15,
wherein the retail processor provides a payment receipt from the retail location.

21. The system according to claim 17,
wherein the intermediary processor provides a confirmation of payment via at least one of the payor email address, the payor address, the payor telephone number and the payor mobile number.

22. The system according to claim 15,
wherein the computing device and the retail processor are located at a shared geographic location.

23. The system according to claim 22,
wherein the payor enters the payment information via at least one of the device, a personal digital assistant (PDA), a mobile device and a set-top box, and
wherein the device comprises a computing device.

24. The system according to claim 16,
wherein the payor enters the payment information to a website implemented by the intermediary entity hosting the intermediary entity processor.

25. The system according to claim 15,
wherein the pre-staged transaction receipt is sent to at least one of: a printer, the device, a personal digital assistant (PDA), a mobile device, a set-top box and a pager, and
wherein the device comprises a computing device.

26. The system according to claim 16,
wherein the intermediary entity stores the pre-staged financial transaction in a database.

27. A tangible computer readable medium that stores a program, recorded on the computer readable medium, for pre-staging a financial transaction, the tangible computer readable medium comprising:
a receiving code segment, recorded on the tangible computer readable medium, that receives payment information for pre-staging the financial transaction from a device over an electronic communication channel;
a sending code segment, recorded on the tangible computer readable medium, that sends a pre-staged transaction receipt to the computing device;
a processing code segment, recorded on the tangible computer readable medium, that processes a payment amount specified by the payment information and the pre-staged transaction receipt, the payment amount and the pre-staged transaction receipt being manually tendered by a user at a retail location.

28. The tangible computer readable medium according to claim 27,
wherein the processing code segment sends a transaction request to an intermediary entity implemented on at least one processor,
wherein the intermediary entity pays a payee the payment amount, based on matching a transaction request from the retail location with the pre-staged financial transaction.

29. A method of pre-staging a financial transaction, comprising:
receiving payment information for pre-staging the financial transaction, from a computing device, via an electronic communication channel;
sending a pre-staged transaction receipt to the computing device;
receiving a transaction request from a retail processor located at a retail location at which a payor manually tenders the pre-staged transaction receipt and a payment amount corresponding to the payment information; and
paying a payee the payment amount based on matching a transaction request from the retail location with the pre-staged financial transaction.

30. An intermediary entity processor, comprising:
a first receiver that receives payment information for pre-staging a financial transaction, from a computing device, via an electronic communication channel;
a transmitter that sends a pre-staged transaction receipt to the computing device;
a second processor that receives a transaction request from a retail location at which a payor manually tenders the pre-staged transaction receipt and a payment amount corresponding to the payment information; and
a match processor that pays a payee the payment amount based on matching a transaction request from the retail location with the pre-staged financial transaction.

31. A tangible computer readable medium storing a program, recorded on the computer readable medium, for pre-staging a financial transaction, the computer readable medium comprising:
a first receiving code segment, recorded on the tangible computer readable medium, that receives payment information for pre-staging the financial transaction, from a computing device, via an electronic communication channel;
a transmitting code segment, recorded on the tangible computer readable medium, that sends a pre-staged transaction receipt to the computing device;
a second receiving code segment, recorded on the tangible computer readable medium, that receives a transaction request from a retail location at which a payor manually tenders the pre-staged transaction receipt and a payment amount corresponding to the payment information; and
a matching code segment, recorded on the tangible computer readable medium, that pays a payee, specified by the payment information, the payment amount based on matching a transaction request from the retail location with the pre-staged financial transaction.

32. A method for pre-staging a financial transaction, comprising:
sending payment information from a computing device for pre-staging the financial transaction, via an electronic communication channel;
receiving a pre-staged transaction receipt corresponding to the financial transaction from an intermediary entity implemented on at least one processor;
receiving a confirmation that a payee, specified by the payment information, has been paid a payment amount corresponding to the payment information, based on matching a transaction request from a retail location with the pre-staged financial transaction, the transaction request being sent based on a payor manually tendering the payment amount and the pre-staged transaction receipt at the retail location.

33. A system for pre-staging a financial transaction, comprising:
a transmitter that transmits payment information from a computing device for pre-staging the financial transaction, via an electronic communication channel;
a receiver that receives a pre-staged transaction receipt corresponding to the financial transaction from an intermediary entity implemented on at least one processor, the receiver receiving a confirmation that a payee, specified by the payment information, has been paid a payment amount corresponding to the payment information, based on matching a transaction request from a retail location with the pre-staged financial transaction, the transaction request being sent based on a payor manually tendering the payment amount and the pre-staged transaction receipt at the retail location.

34. A tangible computer readable medium storing a program, recorded on the computer readable medium, for pre-staging a financial transaction, the computer readable medium comprising:
a sending code segment, recorded on the tangible computer readable medium, that sends payment information from a computing device for pre-staging the financial transaction, via an electronic communication channel;
a receiving code segment, recorded on the tangible computer readable medium, that receives a pre-staged transaction receipt corresponding to the financial transaction;
a second receiving code segment, recorded on the tangible computer readable medium, that receives a confirmation that a payee, specified by the payment information, has been paid a payment amount, based on matching a transaction request from a retail location with the pre-staged financial transaction, the transaction request being sent based on a payor manually tendering the payment amount and the pre-staged transaction receipt at the retail location.

35. A method for pre-staging a financial transaction, comprising:
receiving a pre-staged transaction receipt and a manually tendered payment amount specified by payment information, the payment information being entered via a computing device for pre-staging the financial transaction, the pre-staged transaction receipt being generated in response to entering the payment information;
sending a transaction request to an intermediary entity, the intermediary entity implemented on at least one processor and matching the transaction request with the pre-staged financial transaction,
wherein a payee, specified by the payment information, is paid the payment amount based on matching the transaction request with the pre-staged financial transaction.

36. A system for pre-staging a financial transaction, comprising:
a receiver that receives a pre-staged transaction receipt and a manually tendered payment amount specified by payment information, the payment information being entered via a computing device for pre-staging the financial transaction, the pre-staged transaction receipt generated in response to entering the payment information; and
a transmitter that transmits a transaction request to an intermediary entity, the intermediary entity implemented on at least one processor and matching the transaction request with the pre-staged financial transaction,
wherein a payee, specified by the payment information, is paid the payment amount based on matching the transaction request with the pre-staged financial transaction.

37. A tangible computer readable medium storing a program, recorded on the computer readable medium, for pre-staging a financial transaction, the tangible computer readable medium comprising:
a receiving code segment, recorded on the tangible computer readable medium, that receives a pre-staged transaction receipt and a manually tendered payment amount specified by payment information, the payment information being entered via a computing device for pre-staging the financial transaction, the pre-staged transaction receipt generated in response to entering the payment information; and
a sending code segment, recorded on the tangible computer readable medium, that sends a transaction request to an intermediary entity, the intermediary entity being implemented on at least on processor and matching the transaction request with the pre-staged financial transaction,
wherein a payee, specified by the payment information, is paid the payment amount based on matching the transaction request with the pre-staged financial transaction.
